(19) United States
(12) Patent Application Publication
(10) Pub. No.: US 2015/0149357 A1
(43) Pub. Date: May 28, 2015

(54) MOBILE PAYMENT HOTSPOT

(71) Applicants: James Ioannidis, Palo Alto, CA (US); Niels van Galen Last, Palo Alto, CA (US)

(72) Inventors: James Ioannidis, Palo Alto, CA (US); Niels van Galen Last, Palo Alto, CA (US)

(21) Appl. No.: 14/088,267

(22) Filed: Nov. 22, 2013

(51) Int. Cl. G06Q 20/32

(52) U.S. Cl. CPC G06Q 20/3224; G06Q 20/327
USPC 705/44

(57) ABSTRACT

Exemplary methods, apparatuses, and systems determine that a geolocation of a first mobile device is within a threshold distance from a geolocation of a second mobile device. In response, a list of one or more mobile devices within the threshold distance from the geolocation of the second mobile device, including the first mobile device, are transmitted to the second mobile device. A selection of the first mobile device from the list is received from the second mobile device. A request from the second mobile device to transmit a payment from an account associated with the second mobile device to an account associated with the first mobile device is received from the second mobile device. A confirmation of the requested payment is transmitted to the second mobile device.

### FIELD OF THE INVENTION

The various embodiments described herein relate to executing financial transactions using a mobile device. In particular, embodiments relate to using the location of one or more mobile devices to execute a financial transaction.

### BACKGROUND OF THE INVENTION

Mobile devices facilitate the transmission and receipt of electronic payments in a number of ways. For example, mobile device magnetic stripe readers (e.g., to read a credit or banking card), message-based payments, and near field communication (NFC) are all used to facilitate transmitting or receiving payment using a mobile device. Magnetic stripe readers couple to mobile devices and enable the mobile devices to receive payments. Compact, mobile magnetic stripe readers are available, but a reader is additional hardware, comes at an additional cost, and occupies physical space in addition to the mobile device (i.e., making it less convenient as a mobile solution). Additionally, magnetic stripe readers require payment via a card bearing a magnetic stripe and do not facilitate payment from another mobile device. Banking institutions and other organizations enable mobile device users to transmit payments via text message and email. While message based payments do not require additional hardware, they can be slow and rely on knowing and correctly entering the recipient's phone number or email address. NFC enabled devices (i.e., devices that include a NFC chip) do not require additional hardware, but some mobile devices lack a NFC chip. Additionally, transactions conducted via NFC require contact or near contact between the two NFC enabled devices.

### BRIEF DESCRIPTION OF THE DRAWINGS

The present invention is illustrated by way of example and not limitation in the figures of the accompanying drawings, in which like references indicate similar elements, and in which:

FIG. 1 illustrates, in block diagram form, an exemplary network of processing devices implementing one or more mobile payment hotspots;

FIG. 2 is a flow chart illustrating an exemplary method of a marketplace server facilitating a transaction via a mobile payment hotspot;

FIG. 3 is an exemplary graphical user interface (GUI) illustrating the creation of a mobile payment hotspot;

FIGS. 4A-4B illustrate an exemplary series of GUIs of a mobile device transmitting payment via a mobile payment hotspot;

FIG. 5A-5B illustrate another exemplary series of GUIs of a mobile device transmitting payment via a mobile payment hotspot; and

FIG. 6 illustrates, in block diagram form, an exemplary processing system to transmit a payment, receive a payment, or otherwise facilitate a transaction via a mobile payment hotspot.

### DETAILED DESCRIPTION

Embodiments described herein enable a mobile device to discover mobile payment hotspots based upon the geolocation of the mobile device. In particular, a client mobile device can discover, select, and initiate a single or recurring payment to a nearby vendor mobile device or another mobile payment hotspot established for the geolocation of the client mobile device. Additionally, a vendor device can initiate one or more stationary or transient mobile payment hotspots and list one or more stationary or transient transactions. As a result, client and vendor devices are able to wirelessly conduct secure transactions without the complications of additional hardware, sharing messaging account information, or the restraints of near physical contact.

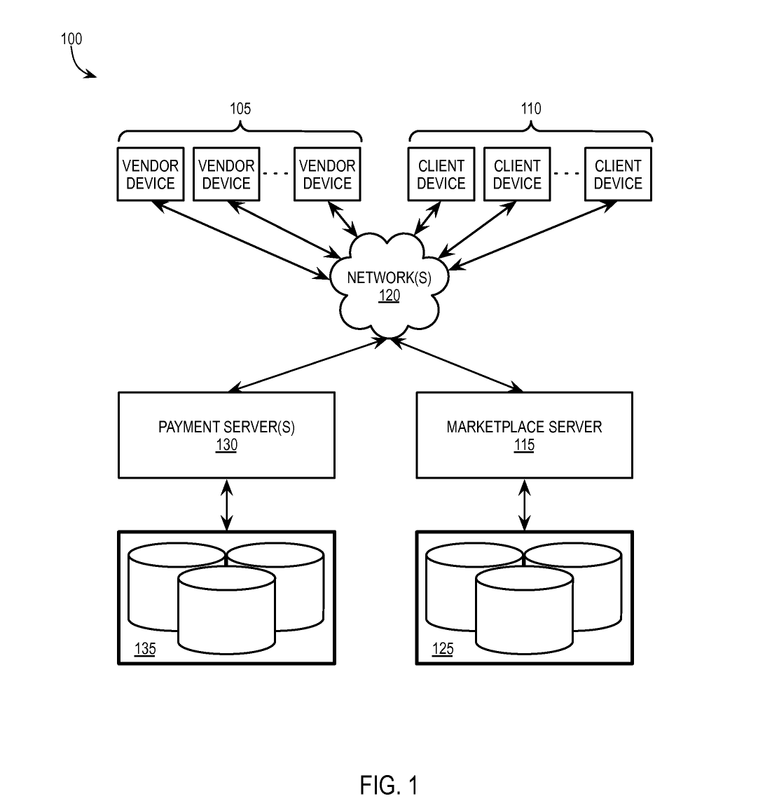

FIG. 1 illustrates, in block diagram form, exemplary network 100 of processing devices implementing one or more payment hotspots. Network 100 includes one or more vendor devices 105 and one or more client devices 110. In one embodiment, a vendor device 105 is a mobile device (e.g., a mobile phone, tablet, or other portable computing device that can access a cellular/wireless network and share its geolocation or otherwise have its geolocation determined). As used herein, geolocation refers to a geographic location of a device that corresponds to an approximate or actual address, position coordinates (e.g., latitude and longitude), or other indication of a physical location of the device. In an alternate embodiment, a vendor device 105 is desktop or other stationary computing device. Client devices 110 are mobile devices that can access a cellular or other wireless network and share device geolocation or otherwise have device geolocation determined. As described in greater detail herein, each client device 110 and, in one embodiment, one or more vendor devices 105, store instructions to execute or otherwise run a web-based application to facilitate transactions via payment hotspots.

Vendor devices 105 and client devices 110 are coupled to marketplace server 115 via one or more networks 120 (e.g., one or more of a local area network, cellular network, or other private or publically accessible wide area network). As used herein, a server refers to a computer that provides a network service. Marketplace server 115 determines the geolocation of vendor devices 105 and client devices 110, maintains a list of active payment hotspots, detects indications of fraudulent transactions, and otherwise facilitates transactions via payment hotspots as described herein. Marketplace server 115 is coupled to and utilizes marketplace datastore(s) 125 to store user records and metadata, transaction histories, available transactions (e.g., items, services, etc. to which payments may be applied), geolocation restraints for payment hotspots or transactions, and other transaction data described herein.

Marketplace server 115 is also coupled to payment server(s) 130 via network(s) 120. Exemplary payment servers 130 include servers maintained by credit card, banking, and other financial institutions/organizations that provide accounts for individuals and organizations. Information for such accounts is stored in payment datastore(s) 135, which are coupled to payment servers 130. For example, a client device 110 may instruct marketplace server 115 to transfer funds (e.g., physical or digital currency) from an account managed by a payment server 130 to a vendor's account managed by the same or another payment server 130.

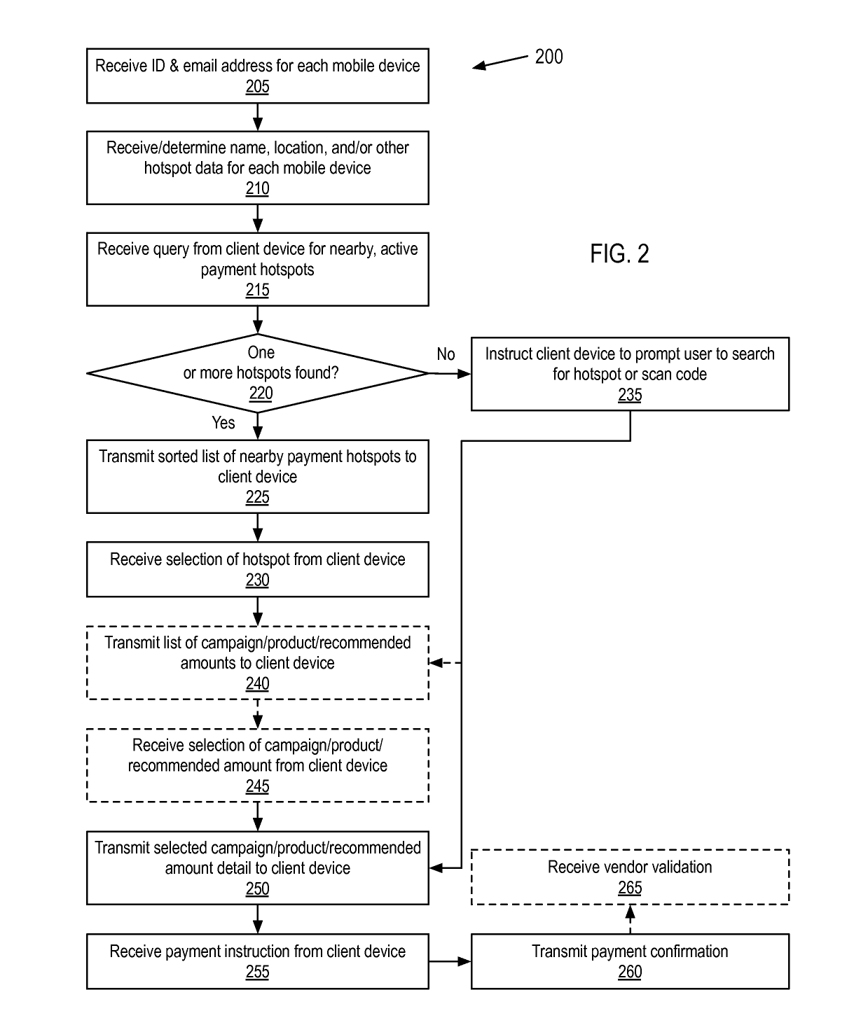

FIG. 2 is a flow chart illustrating exemplary method 200 of a computer (e.g., marketplace server 115) facilitating a transaction via a mobile payment hotspot. At block 205, the computer receives a unique identifier and email address for each vendor device 105 and client device 110. For example, the computer may receive a universally unique identifier (UUID) or other unique identifier along with a user's email address associated with the corresponding device 105/110. In one embodiment, the computer requests the unique identifier and email address. Alternatively, each vendor device 105 and client device 110 automatically transmits a unique identifier and email address pair as a part of logging on and/or heartbeat signal.

At block 210, the computer receives or determines a name, geolocation, and/or other payment hotspot data for each device 105/110. The computer retrieves the name and/or other user data using the unique identifier and email address. For example, the computer maintains a user account database that maps the unique identifier and email address pair to client/vendor name, transaction history for the client/vendor, trust data associated with the vendor, mobile payment hotspots for the vendor, available transactions for each payment hotspot, geolocation data for mobile payment hotspots/available transactions, etc. In one embodiment, the computer maps multiple unique identifiers and/or multiple email addresses to a single user account and the corresponding account data.

As listed above, the computer also receives or determines the geolocation of the device 105/110. For example, the computer receives global positioning system (GPS), assisted GPS, or other location data from the device 105/110. In one embodiment, the computer receives from the device 105/110 an Internet Protocol (IP) address, cellular/radio tower identifiers or signal strengths, and/or identifiers of one or more wireless networks within range of the device 105/110 and determines or confirms the geolocation using the IP address, radio tower data, and/or network identifiers. For example, the computer stores (e.g., in marketplace datastore(s) 125) or otherwise accesses a lookup table to map an IP address or network identifier to a geolocation. In one embodiment, the geolocation of the device 105/110 includes an altitude of the device 105/110. For example, a payment hotspot activated in an airplane or in the upper floors of a tall building may be very close in latitude and longitude to a client device 110 on the ground but the difference in altitude (and therefore distance) between the client device 110 and the payment hotspot may be quite large.

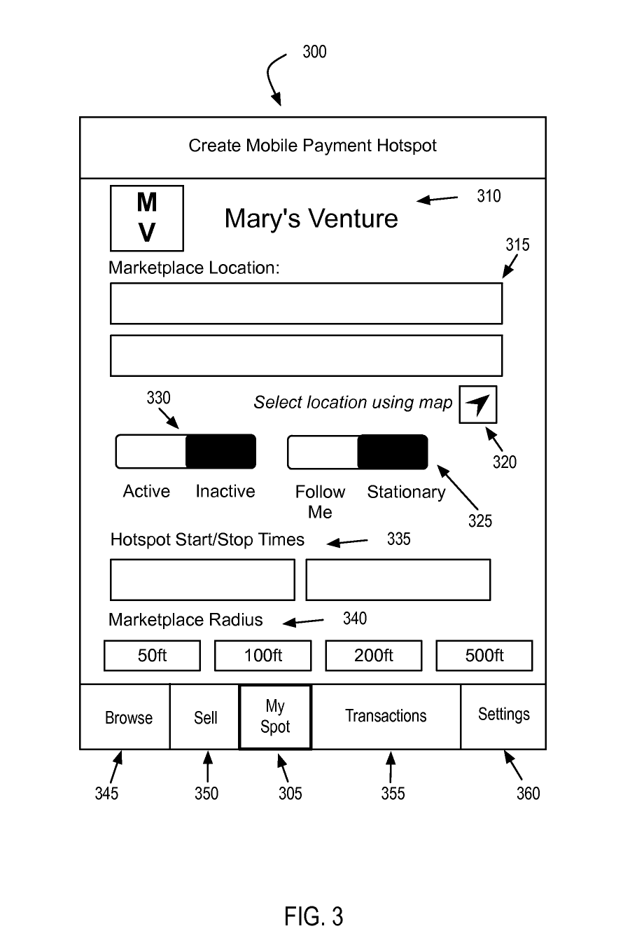

In one embodiment, the computer receives input from a vendor device 105 to create or to activate a previously created payment hotspot. The various data that may be received in creating or activating a payment hotspot are described with reference to FIG. 3 and inputs received by vendor device 105.

FIG. 3 is graphical user interface (GUI) 300 illustrating an exemplary creation of a mobile payment hotspot. For example, vendor device 105 may receive selection of GUI element 305 to create or launch a payment hotspot. If multiple payment hotspots had been previously created, vendor device 105 receives selection of a payment hotspot to activate or otherwise edit. As a result, name and logo 310 are displayed within GUI 300 along with various input elements and boxes. If the payment hotspot had not been previously established or if the vendor wishes to edit name and logo 310, vendor device 105 receives input to enter/update name or logo 310 (e.g., by selecting name or logo 310).

GUI 300 includes location input boxes 315 to enable manual input of an address or position coordinates of the payment hotspot. Alternatively, vendor device 105 receives location data via a map interface launched in response to receiving selection of positioning element 320. For example, the map interface may show a current location of vendor device 105 and enable a user to scroll, zoom, and select a location of the payment hotspot. In one embodiment, the map interface enables a user to select the current location of vendor device 105. Additionally, vendor device 105 may receive a request via input element 325 to toggle between a stationary location (e.g., entered as described above) and transient locations (e.g., “Follow Me”), such that the computer will periodically receive or determine a location for vendor device 105 and update the payment hotspot location accordingly. For example, the “Follow Me” setting enables the vendor device 105 to move between locations that are at a greater distance than a marketplace radius (described below). In one embodiment, selection of “Follow Me” via input element 325 defaults to use of the current location of vendor device 105 and does not require or ignores location data provided via input boxes 315 or the map launched in response to selection of positioning element 320. Selection of “Stationary” via input element 325, however, enables vendor device 105 to utilize a current location of vendor device 105 or a different location.

In one embodiment, GUI 300 enables a user to create or edit a payment hotspot for later use. In other words, the payment hotspot may remain inactive until activated by a separate input received via GUI 300. Once a payment hotspot is activated, vendor device 105 transmits an indication to marketplace server 115 that vendor device 105 is ready to receive one or more payments. In response to receiving indication that a payment hotspot is active, marketplace server 115 adds the payment hotspot to a list of active payment hotspots used to determine nearby payment hotspots for client devices 110. For example, active/inactive input element 330 enables the manual activation and deactivation of a payment hotspot. While active, vendor device 105 transmits a heartbeat or other indication of activity to marketplace server 115. In one embodiment, vendor device 105 receives start and/or stop times 335 for the activation and/or deactivation of the payment hotspot. Start and/or stop times 335 may be used in combination with manual activation/deactivation 330 (e.g., manually activate and automatically deactivate at a stop time or automatically activate at a start time and manually deactivate) or without manual activation/deactivation 330. If only one of the start and stop times 335 is entered, vendor device 105 will rely on manual deactivation/activation 330 as a default.

For example, a musician performing at a street fair or festival may set up a payment hotspot with start and stop times 335 for when she is performing and selling her music. With the designated start and stop times 335, the musician's vendor device 105 does not need to be active during that window of time and does not need to transmit a heartbeat. As a result, the musician is able to set up the payment hotspot in advance and users of client devices 110 are able to donate or contribute money to the musician for the performance, purchase music, etc. via the payment hotspot during the time window and without the musician needing to further utilize her vendor device 105 during the operation of the payment hotspot. During or after the time window, the musician is able to log in to her account (e.g., using vendor device 105) and see a record of transactions, direct payments to a financial account, etc.

GUI 300 further includes an indication of marketplace radius 340 of the payment hotspot. Marketplace radius 340 serves as a threshold distance from the payment hotspot location described above within which client devices 110 are able to discover the payment hotspot. While “radius” implies a circular threshold distance in all directions, marketplace radius 340 may be defined in non-circular threshold areas. For example, marketplace radius 340 may be defined to conform to city blocks or to another area. In one embodiment, marketplace radius 340 is selected via user input in GUI 300. Alternatively, marketplace server 115 provides vendor device 105 with a value for marketplace radius 340. For example, marketplace server 115 may determine the radius based upon a trust score for the vendor (described further below). A higher trust score may correlate to a greater radius. In yet another embodiment, marketplace radius 340 is selected via user input up to a maximum value determined by marketplace server 115.

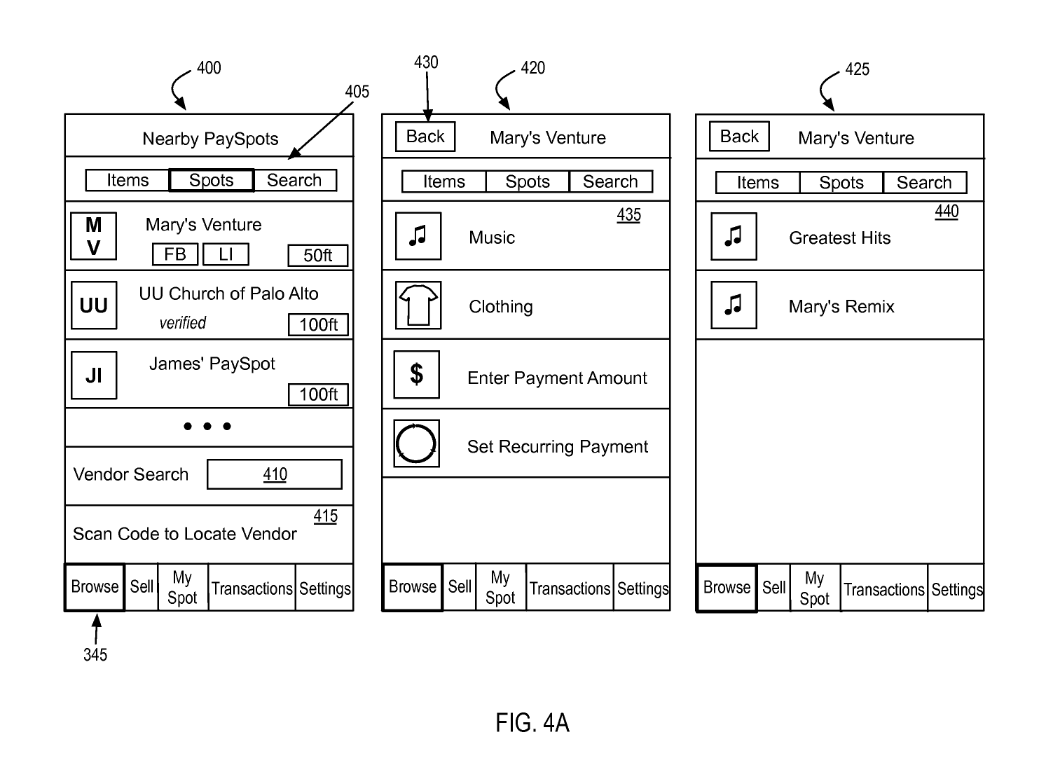

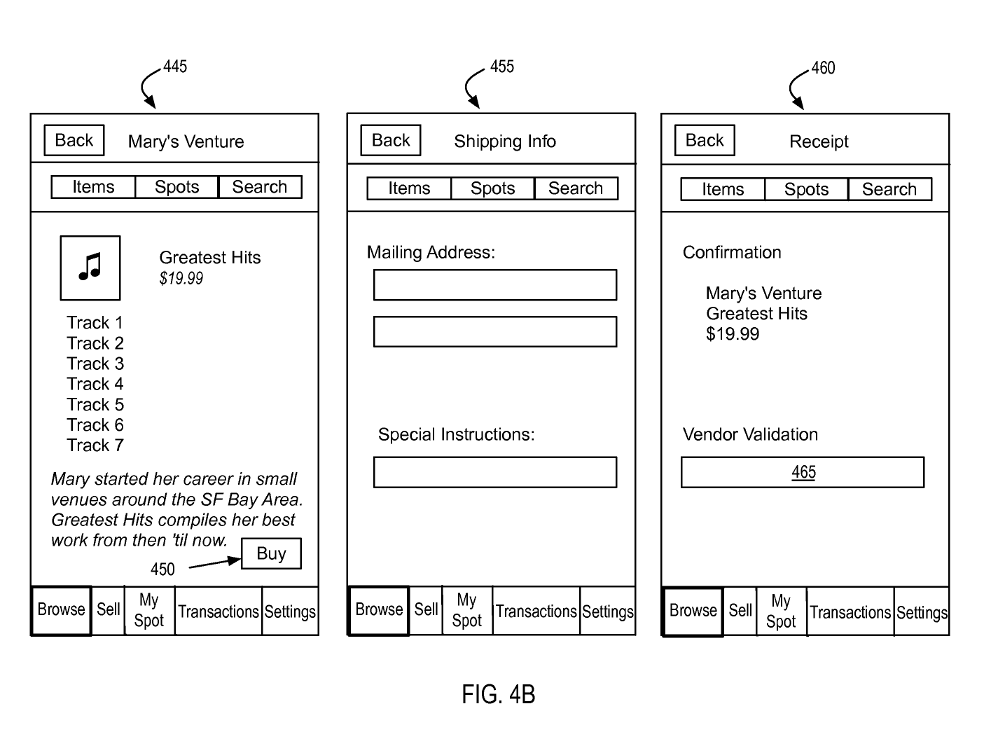

Selection of browse input element 345 results in launching a GUI to enable the user to browse (e.g., as a client device 110) other payment hotspots. Browsing payment hotspots will be described in greater detail with reference to FIG. 4A.

Selection of sell input element 350 results in launching a GUI to enable the user to use a camera (e.g., built-in camera of the device) and/or a graphical user interface to list an item, service, or otherwise advertise a transaction within a payment hotspot. For example, the user may use vendor device 105 to take a photograph of an item for sale, add a description of the item, add a price for the item, etc. In one embodiment, similar to the creation of a payment hotspot, the creation of a listing for an item, service, or other transaction (collectively referred to as an “item”) includes receiving a location. The input elements for designating an item location and otherwise listing an item are similar to input elements 310-40 and, therefore, not separately illustrated. For example, an item may be given a stationary location while the payment hotspot that lists said item is set to “Follow Me” using input element 325. While vendor device 105 remains within a default/selected radius of the stationary location for the item, the item will be advertised within a list of payment options for the payment hotspot. When vendor device leaves that radius, however, the item is omitted from the list of payment options.

Selection of transactions input element 355 results in launching a GUI to enable the user to view past transactions. In one embodiment, transactions input element 355 is context sensitive. For example, selection of transactions input element 355 within a GUI for a particular payment hotspot results in a display of past transactions for that payment hotspot. Selection of transactions input element 355 within a more general context, however, results in the display of all past transactions for the vendor/client account.

Selection of settings input element 360 results in launching a GUI to enable the user to edit account settings. Exemplary settings may include default payment hotspot settings, user login name and password, financial account details to make/receive payments, authorization or deauthorization of a device 105/110, etc. In one embodiment, the vendor/client device 105/110 receives and/or stores encrypted financial account details and transmits the encrypted financial account details to marketplace server 115 to complete a transaction, but the financial account details are not stored permanently by marketplace server 115. In an alternate embodiment, marketplace server 115 stores encrypted financial account details (e.g., in marketplace datastore(s) 125) for use in later transactions and does not require the vendor/client device 105/110 to repeatedly transmit the encrypted financial account details for each transaction.

Returning to FIG. 2, at block 215, the computer receives a query from a client device 110 for nearby, active payment hotspots. For example, client device 110 may send such a query in response to launching a payment hotspot application on client device 110 (i.e., a default/homepage is a listing of nearby, active payment hotspots) or in response to receiving selection of browse input element 345. Alternatively, the computer automatically transmits a list of nearby, active payment hotspots without first receiving a request from client device 110.

At block 220, the computer determines if one or more payment hotspots are found to be active and within a threshold distance of the geolocation of client device 110. As described above, the computer receives an indication of a payment hotspot being active from a vendor device 105. In response to the indication of activity, the payment hotspot may be included in a list of payment hotspots that are nearby to (within a threshold distance of) client device 110. In one embodiment, the threshold distance is individual to each payment hotspot and/or item associated with a payment hotspot. For example, the computer receives indication of active payment hotspots (e.g., in response to user input via element 330/335 and/or heartbeat from vendor device 105). Default or selected threshold distances are assigned to each payment hotspot and may be assigned to individual items within payment hotspots. For example, a first payment hotspot may have a marketplace radius 340 of 50 feet while a second payment hotspot may have a marketplace radius of 500 feet. Additionally, each radius may have a different center location or otherwise cover a different geographical area. Furthermore, payment hotspots established with the “Follow Me” setting via input element 325 may be in transit. In one embodiment, the computer calculates an estimated rate of change between the determined geolocations of the vendor device 105 set to “Follow Me” and, based on that estimated rate of change, projects a future location of vendor device 105 for the time when the list of nearby hotspots is generated and transmitted to client device 110. As a result, the computer determines from a maintained listing of currently active stationary and transient payment hotspots which marketplace/item radii or geographic areas include or will include the geolocation of client device 110.

If client device 110 is within a threshold distance of one or more nearby, active payment hotspots, at block 225, the computer transmits a list of the one or more nearby, active payment hotspots to client device 110. As will be described in additional detail herein, the list may be simply a listing of nearby, active payment hotspots or a listing of items available via nearby, active payment hotspots. In one embodiment, the computer (or client device 110) sorts the list in an order according to one or more of: 1) the distance between client device 110 and each payment hotspot (e.g., computed using latitude and longitude and, in some embodiments, altitude), 2) the trust rating of each payment hotspot, 3) the number of previous transactions between client device 110 and each payment hotspot, 4) the number of previous interactions between client device 110 and each payment hotspot (e.g., number of times a payment hotspot is selected or browsed), 5) the transaction history for each payment hotspot (e.g., total number of transactions, number of transactions over a period of time, etc.) 6) popularity of each payment hotspot based upon unique transactions and/or an interaction history for each payment hotspot (e.g., the number of users browsing the payment hotspot), 7) reviews of the vendor/payment hotspot on another network service, 8) the marketplace radius for each payment hotspot (e.g., a larger radius may correlate to a higher ranking in the ordered list), 9) the timeframe for each payment hotspot (e.g., a payment hotspot that will soon become inactive due to a vendor-selected end time may be given a higher ranking in the ordered list than a payment hotspot that is not going to become inactive soon), and 10) a time at which each payment hotspot became active (e.g., a payment hotspot that became active at a similar time to client device 110 may be given a higher ranking in the ordered list than a payment hotspot that became active much sooner/later than client device 110).

In one embodiment, the computer calculates a trust rating for a payment hotspot/vendor account (and, as applicable, for a client account). As described above, the trust rating may be used as a factor in ordering the list of nearby, active payment hotspots for a given client device 110. In one embodiment, a trust rating is transmitted along with payment hotspot information for display on client device 110. Exemplary factors used in calculating the trust include one or more of: 1) a number of network service or social network accounts linked to the vendor account, 2) metadata for the vendor obtained from network service or social network accounts linked to the vendor account, 3) reviews of the vendor on other network services or social networks, 4) search engine search results for the vendor, 5) confirmed financial account information provided by the vendor, 6) contact or other personal information provided by the vendor, 7) a number of complaints received by users about the vendor account/payment hotspot, 8) the number/content of reviews of the vendor account/payment hotspot, 9) the number of transactions completed by the vendor account/payment hotspot, 10) the amount of payments received by the vendor account/payment hotspot, 11) the number of unique client accounts that have transacted with the vendor account/payment hotspot, 12) the length of time the vendor account/payment hotspot has existed, 13) manual review/confirmation of the vendor account/payment hotspot, and 14) fraud signals for the vendor account/payment hotspot.

In one embodiment, the computer further calculates fraud signals for each device 105/110. As described above, a fraud signal can be used to decrease a payment hotspot's rank in an ordered list (e.g., for a weak fraud signal). Additionally, the computer may prevent a transaction from completing or omit a payment hotspot from the ordered list in response to a fraud signal (e.g., for a strong fraud signal). In one embodiment, the strength of the fraud signal depends upon the type and number of signals that occur. Exemplary fraud signals include 1) receiving a device geolocation that doesn't correspond to a determined location of an IP address or network identifier, 2) calculating an estimated rate of change of device geolocations over time and receiving a device geolocation doesn't correspond to the estimated rate of change, 3) determining that a client account has passed a threshold number of transactions within a period of time, 4) determining that an account has passed a threshold total value amount (e.g., in dollars) of one or more pending/recently processed transactions, the threshold based upon a transaction history for the account, 5) the use of an anonymizing proxy, 6) a device preventing tracking of information about the device, 7) an account/payment hotspot flagged in response to a complaint, previous fraudulent activity, etc., 8) the device geolocation being beyond a threshold distance of address information stored for the associated account, and 9) the geolocation of the device failing to exhibit the natural drift expected of a positioning signal. For example, the computer may determine a plurality geolocations of a mobile device 105/110 over time. Using the plurality of geolocations and the amount of time that passes between each determination of geolocation, the computer calculates an estimated rate of change between the determined geolocations of the mobile device 105/110. The computer then determines that an updated geolocation of the mobile device 105/110 is at a distance greater than a threshold distance from a recent geolocation based upon the estimated rate of change. As a result, the computer prevents a transaction for or omits the mobile device 105/110 from a listing of payment hotspots.

FIGS. 4A-4B illustrate an exemplary series of GUIs of a client device 110 receiving a sorted list of nearby payment hotspots and transmitting payment via a selected mobile payment hotspot. In particular, GUI 400 displays a sorted list of nearby payment hotspots received from marketplace server 115. For example, the sorted list is received from marketplace server 115 in response to selecting (and transmitting a corresponding request to marketplace server 115) browse input element 345, spots input element in browse menu 405, or by default upon launching a mobile payment hotspot application. The sorted list includes Mary's Venture, UU Church of Palo Alto, and James' PaySpot. Each payment hotspot listing includes a distance from client device 110 as well as indications of linked network service/social media accounts, verification of accounts, etc. Mary's Venture is listed first because it is the closest payment hotspot to client device 110, at a distance of 50 feet, and because it includes two linked social media accounts, FB and LI. UU Church of Palo Alto is listed second because it is a verified payment hotspot/account and at a distance of 100 feet. While James' PaySpot is also at a distance of 100 feet, it is not verified or illustrated as including any other factors to increase its ranked order in the list. As a result, James' PaySpot is listed after UU Church of Palo Alto at third in the list. As described above, marketplace server 115 may use one or more other factors to sort the list in a ranked order. Additionally, as illustrated by the ellipses following James's PaySpot in GUI 400, additional payment hotspots may be included in the list and displayed, e.g., by scrolling through the list.

In one embodiment, in response to selecting (and transmitting a corresponding request to marketplace server 115) items input element in browse menu 405, GUI 400 receives and displays a sorted list of items/transactions available at nearby, active payment hotspots. For example, the listing of Mary's Venture may further include a listing of an item being sold by Mary, the listing of UU Church of Palo Alto may further include a listing of a recommended donation amount, and the listing of James' PaySpot may include a service that may be purchased form James. In one embodiment, the sorted list of items includes multiple item listings for a single payment hotspot. For example, if Mary is selling multiple items via Mary's Venture, each item may be given a separate listing within the sorted list of items. In addition to the sorting factors described above, in one embodiment, marketplace server 115 or client device 110 sorts the list of items based upon one or more of: 1) the client account's transaction history (e.g., giving a higher list ranking to repeat transactions), 2) popularity of items (e.g., based upon total transactions, browsing of items, reviews of items, etc.), and 3) a threshold number of items to be displayed per payment hotspot (e.g., to prevent a single payment hotspot with a large number of items from dominating the items list).

GUI 400 further includes a vendor search input box 410 to enable a user to enter an alphanumeric search term to locate a nearby payment hotspot. GUI 400 also includes scan input element 415 to launch a built-in camera or other scanning device of client device 110. Client device 110 then may scan or otherwise capture and decode a barcode (e.g., a QR code) to search for a nearby payment hotspot using data encoded within the barcode.

Returning to FIG. 2, at block 230, the computer receives selection of a payment hotspot from client device 110. For example, in GUI 400, the user of client device 110 may select Mary's Venture from the displayed list of payment hotspots. In response to the user input, client device 110 transmits the selection to marketplace server 115. Additionally, as described above, selection of a payment hotspot may result from a vendor search utilizing search input box 410 or from scanning a bar code after launching a scanner via scan input element 415. Similarly, if no nearby payment hotspots are initially found in block 220, the computer instructs client device 110 to prompt the user to search for a payment hotspot using search input box 410 or scan input element 415 at block 235 and a payment hotspot is selected via the search or scan.

If the selected payment hotspot includes multiple items, at block 240, the computer transmits a list of items or categories of items to client device 110. As stated above, an item as used herein may refer to a product, service, campaign/donation amount, or other transaction. Referring again to FIG. 4A, GUI 420 includes an exemplary list of item categories available within the payment hotspot, Mary's Venture. Items are grouped in the categories of music and clothing. Additionally, the user may select to directly enter a payment amount or set a recurring payment. Similarly, GUI 425 includes an exemplary list of items. In one embodiment, client device 110 displays GUI 425 in response to selection of a category in GUI 420. For example, user selection of music 435 results in the display of items within that category in GUI 425 (e.g., via request and reply with marketplace server 115). Alternatively, GUI 425 is displayed in response to selection of the payment hotspot and includes all items within that payment hotspot.

GUI's 420 and 425 each include a back input element 430 to navigate to a previously displayed GUI. For example, selection of back input element 430 in GUI 420 would result in client device 110 returning to GUI 400 and selection of back input element 430 in GUI 425 would result in client device 110 returning to GUI 420.

Returning to FIG. 2, at block 245, the computer receives a selection of an item from client device 110. For example, referring again to FIG. 4A, a user may select Greatest Hits 440 in GUI 425. In response to the selection, client device 110 transmits the selection to marketplace server 115.

At block 250, the computer transmits the selected item details to client device 110 in response to receiving a selected item. For example, referring to FIG. 4B, GUI 445 includes the details of the item, Greatest Hits 440, selected in GUI 425. In addition to details about the item, GUI 445 includes a purchase input element 450 to enable the user of client device 110 initiate the purchase of the displayed item. In an alternate embodiment, the computer transmits the selected item details to client device 110 in response to receiving a selection of a payment hotspot. For example, if the payment hotspot only includes a single item, selection of the payment hotspot may result in directly displaying details of that single item.

At block 255, the computer receives a payment instruction from client device 110. For example, referring again to FIG. 4B, selection of purchase input element 450 in GUI 445 results in client device 110 transmitting a payment instruction to marketplace server 115. In one embodiment, client device 110 further transmits encrypted payment account information along with the payment instruction. Alternatively, marketplace server 115 retrieves payment account information from marketplace datastore(s) 125, e.g., using the unique identifier and email address pair for client device 110.

In one embodiment, transmitting the payment instruction further includes providing a mailing address, special instructions, or other details for the completion of the transaction. For example, referring again to FIG. 4B, in response to user selection of purchase input element 450, client device 110 displays GUI 455 to enable the user to enter a mailing address or special instructions.

At block 260, the computer transmits payment confirmation. Payment confirmation is transmitted to one or both of vendor device 105 and client device 110. For example, in response to receiving the payment instruction, marketplace server 115 transmits notification to vendor device 105 or vendor account based upon the unique identifier and email address associated with the payment hotspot. Even if the vendor has yet to provide financial account information to receive payment, marketplace server 115 is able to initiate the payment from the client. Once the vendor provides the receiving financial account information, the processing of the payment to the vendor is completed. In one embodiment, transmission of the payment confirmation to vendor device 110 includes transmitting the mailing address, special instructions, or other information entered in GUI 455.

Similarly, marketplace server 115 may transmit a digital receipt to client device 110. Referring again to FIG. 4B, GUI 460 includes a receipt to confirm the purchase of Greatest Hits from Mary's Venture.

In one embodiment, transmission of payment confirmation is transmitted to vendor device 105 in response to determining that client device 110 has reached a threshold distance from the payment hotspot or a particular location within/outside of the payment hotspot. For example, a user performs a self-checkout using client device 110 to pay for one or more items. A unique identifier for the user's client device 110 is stored in association with the purchase. Marketplace server 115 continues to determine the geolocation of the client device 110, e.g., using assisted GPS, triangulation of wireless access point signals, etc. As marketplace server 115 determines from the geolocation of client device 110 that the user is leaving the virtual or physical storefront, and therefore not purchasing any additional items, marketplace server 115 transmits the payment confirmation or another message to vendor device 105 listing the item(s) purchased by the user via the payment hotspot. In one embodiment, the message includes a profile picture of the user of client device 110, an indication if the user has been flagged as a risk for theft, the time the user spent in the store, and/or the parts of the store in which the user spent time. The user of vendor device 105, in response to the message, is then able to visually inspect that the user of client device 110 is leaving the storefront with only the items purchased.

In one embodiment, the transaction is not complete until a vendor validation is received in response to the payment confirmation at block 265. For example, GUI 460 includes vendor validation input box 465. The vendor can enter a validation code or provide a validation code to the client to enter in validation input box 465 to complete the transaction. As a result, the client and vendor can complete the transaction using a single mobile device, e.g., client device 110, at the time of the transaction.

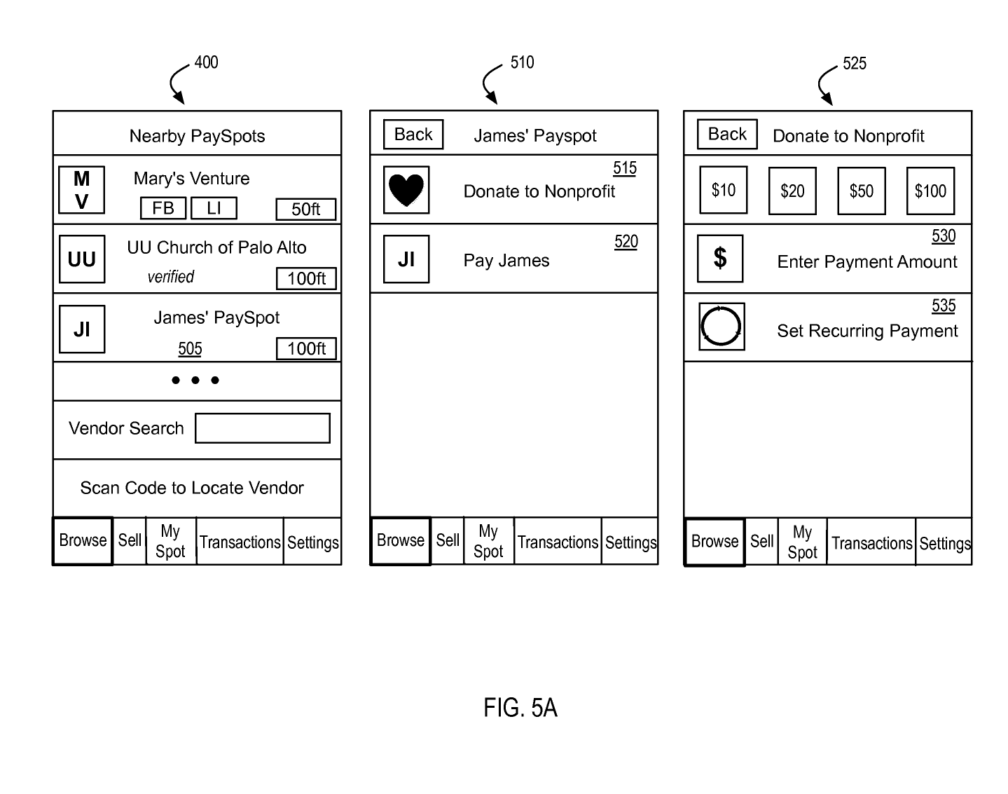

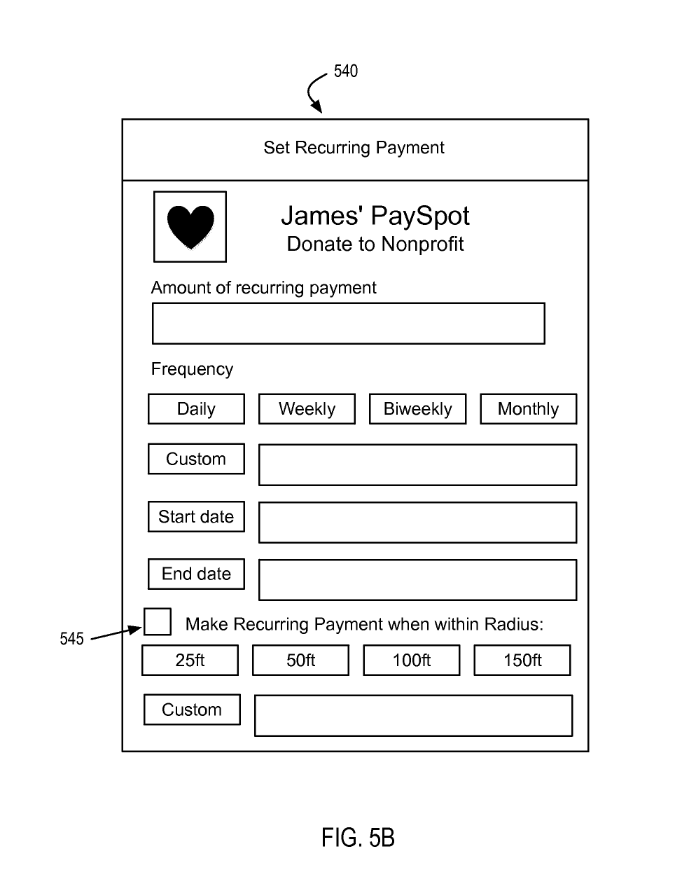

FIG. 5A-5B illustrate another exemplary series of GUIs of a client device 110 receiving a sorted list of nearby payment hotspots and transmitting payment via a selected mobile payment hotspot. In response to selecting a payment hotspot, James' PaySpot 505, client device 110 (e.g., based upon sending requests to and receiving data from marketplace server 115) displays GUI 510. In one embodiment, a single vendor account is linked to multiple financial accounts. For example, GUI 510 includes two categories, a category for making a donation to a nonprofit 515 and a category for making a payment directly to James 520. Donations made to the nonprofit will result in funds being sent to a financial account managed by the nonprofit. Payments made to James, however, result in funds being sent to a personal financial account for James.

In response to selecting the category for making a donation to a nonprofit 515, client device 110 (e.g., based upon sending requests to and receiving data from marketplace server 115) displays GUI 525. GUI 525 includes selectable suggested donation amounts of $10, $20, $50, and $100, payment amount input element 530, and recurring payment input element 535. Selection of a suggested donation amount initiates a payment in the corresponding amount. Selection of payment amount input element 530 launches a GUI or element within GUI 525 to enable the user to enter a donation amount. In response to selection of recurring payment input element 535, client device 110 (e.g., based upon sending requests to and receiving data from marketplace server 115) displays GUI 540.

GUI 540 includes input boxes and elements to designate a recurring payment amount, frequency, start date, end date, etc. Additionally, in one embodiment, the user of client device 110 can set a geolocation trigger for making recurring payments. In other words, the recurring payment is made based upon geolocation of client device 110 rather than simply relying on scheduling payments by dates on a calendar. GUI 540 includes geolocation trigger input element 545 to enable the user to select a threshold distance from a payment hotspot/vendor device 105 at which the recurring payment is triggered. For example, if client device 110 is used to make payments for a regular yoga class, the user may select a recurring payment in the amount of the daily rate for the class that automatically is paid when the user attends the class, and therefore is within the selected threshold distance of the payment hotspot. Once the recurring payment is established with a geolocation trigger, the recurring payment information is transmitted to marketplace server 115. When the conditions for the recurring payment are met, e.g., when the user is within the threshold distance of the payment hotspot/vendor device 105 and, the frequency date is satisfied (if required), payment to the vendor is initiated. As a result, payments are automatically made when the user attends the yoga class but not when the user misses a class or is in the designated geolocation on a date that does not match the recurrence frequency/date of the class.

In one embodiment, the vendor account is attributed or otherwise credited for collecting payment on behalf of an organization. For example, a non-profit may want to track the amount of donations collected by individuals or teams. Additionally, organizations may want to track sales made by individual employees for evaluations, commissions, etc. As a result, a financial account receiving payments is associated with a plurality of client devices 110 representing different individuals. In response to one of the client devices 110 collecting a payment, marketplace server 115 generates a record to attribute the payment to the corresponding user. The record is transmitted to or otherwise made available to a manager of the account (e.g., the nonprofit). In one embodiment in which the record is used to award commissions, marketplace server 115 automatically splits the payment to award the commission to the individual and the remainder of the payment to the organization.

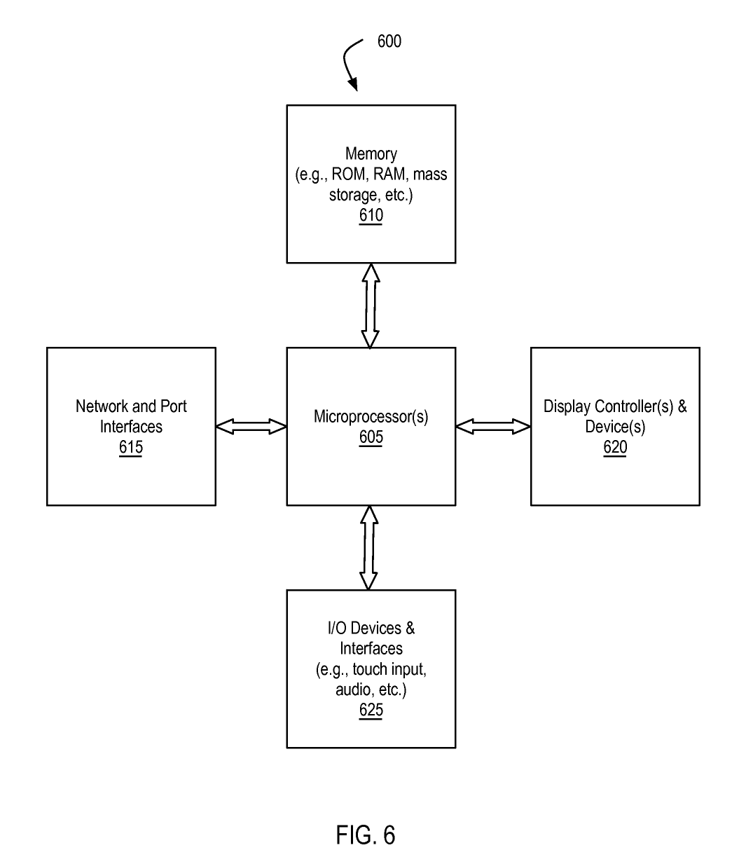

FIG. 6 illustrates, in block diagram form, an exemplary processing system to transmit a payment, receive a payment, or otherwise facilitate a transaction via a mobile payment hotspot. Data processing system 600 (also referred to herein as a “computer” or “mobile device”) includes one or more microprocessors 605 and connected system components (e.g., multiple connected chips). Alternatively, data processing system 600 is a system on a chip.

Data processing system 600 includes memory 610, which is coupled to microprocessor(s) 605. Memory 610 may be used for storing data, metadata, and programs for execution by the microprocessor(s) 605. Memory 610 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 610 may be internal or distributed memory.

Data processing system 600 includes network and port interfaces 615, such as a port, connector for a dock, or a connector for a USB interface, FireWire, Thunderbolt, Ethernet, Fibre Channel, etc. to connect the system 600 with another device, external component, or a network. Exemplary network and port interfaces 615 also include wireless transceivers, such as an IEEE 802.11 transceiver, an infrared transceiver, a Bluetooth transceiver, a wireless cellular telephony transceiver (e.g., 2G, 3G, 4G, etc.), or another wireless protocol to connect data processing system 600 with another device, external component, or a network and receive stored instructions, data, tokens, etc. In one embodiment, system 600 includes a GPS or other positioning receiver to receive positioning data and determine a geolocation of system 600.

Data processing system 600 also includes display controller and display device 620 and one or more input or output (“I/O”) devices and interfaces 625. Display controller and display device 620 provides a visual user interface for the user. I/O devices 625 allow a user to provide input to, receive output from, and otherwise transfer data to and from the system. I/O devices 625 may include a mouse, keypad or a keyboard, a touch panel or a multi-touch input panel, camera, optical scanner, audio input/output (e.g., microphone and/or a speaker), other known I/O devices or a combination of such I/O devices.

It will be appreciated that one or more buses, may be used to interconnect the various components shown in FIG. 6.

Data processing system 600 is an exemplary representation of one or more of vendor device(s) 105, client device(s) 110, marketplace server 115, marketplace datastore(s) 125, payment server(s) 130, and payment datastore(s) 135 described above. Data processing system 600 may be a personal computer, tablet-style device, a personal digital assistant (PDA), a cellular telephone with PDA-like functionality, a Wi-Fi based telephone, a handheld computer which includes a cellular telephone, a media player, an entertainment system, or devices which combine aspects or functions of these devices, such as a media player combined with a PDA and a cellular telephone in one device. In other embodiments, data processing system 600 may be a network computer, server, or an embedded processing device within another device or consumer electronic product. As used herein, the terms computer, device, system, processing system, processing device, and “apparatus comprising a processing device” may be used interchangeably with data processing system 600 and include the above-listed exemplary embodiments.

It will be appreciated that additional components, not shown, may also be part of data processing system 600, and, in certain embodiments, fewer components than that shown in FIG. 6 may also be used in data processing system 600. It will be apparent from this description that aspects of the inventions may be embodied, at least in part, in software. That is, the computer-implemented method 200 may be carried out in a computer system or other data processing system 600 in response to its processor or processing system 605 executing sequences of instructions contained in a memory, such as memory 610 or other non-transitory machine-readable storage medium. The software may further be transmitted or received over a network (not shown) via network interface device 615. In various embodiments, hardwired circuitry may be used in combination with the software instructions to implement the present embodiments. Thus, the techniques are not limited to any specific combination of hardware circuitry and software, or to any particular source for the instructions executed by data processing system 600.

An article of manufacture may be used to store program code providing at least some of the functionality of the embodiments described above. Additionally, an article of manufacture may be used to store program code created using at least some of the functionality of the embodiments described above. An article of manufacture that stores program code may be embodied as, but is not limited to, one or more memories (e.g., one or more flash memories, random access memories—static, dynamic, or other), optical disks, CD-ROMs, DVD-ROMs, EPROMs, EEPROMs, magnetic or optical cards or other type of non-transitory machine-readable media suitable for storing electronic instructions. Additionally, embodiments of the invention may be implemented in, but not limited to, hardware or firmware utilizing an FPGA, ASIC, a processor, a computer, or a computer system including a network. Modules and components of hardware or software implementations can be divided or combined without significantly altering embodiments of the invention.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. References in the specification to “one embodiment,” “an embodiment,” “an exemplary embodiment,” etc., indicate that the embodiment described may include a particular feature, structure, or characteristic, but not every embodiment may necessarily include the particular feature, structure, or characteristic. Moreover, such phrases are not necessarily referring to the same embodiment. Furthermore, when a particular feature, structure, or characteristic is described in connection with an embodiment, such feature, structure, or characteristic may be implemented in connection with other embodiments whether or not explicitly described. Blocks with dashed borders (e.g., large dashes, small dashes, dot-dash, dots) are used herein to illustrate optional operations that add additional features to embodiments of the invention. However, such notation should not be taken to mean that these are the only options or optional operations, and/or that blocks with solid borders are not optional in certain embodiments of the invention. Numerous specific details are described to provide a thorough understanding of various embodiments of the present invention. However, in certain instances, well-known or conventional details are not described in order to provide a concise discussion of embodiments of the present inventions.

It will be evident that various modifications may be made thereto without departing from the broader spirit and scope of the invention as set forth in the following claims. For example, the methods described herein may be performed with fewer or more features/blocks or the features/blocks may be performed in differing orders. Additionally, the methods described herein may be repeated or performed in parallel with one another or in parallel with different instances of the same or similar methods.

What is claimed is:

1. A computer-implemented method, comprising:
determining, by a computer, that a geolocation of a first mobile device is within a threshold distance from a geolocation of a second mobile device;
transmitting, by the computer to the second mobile device, a list of one or more mobile devices within the threshold distance from the geolocation of the second mobile device, the list including the first mobile device;
receiving, by the computer from the second mobile device, a selection of the first mobile device from the list;
receiving, by the computer from the second mobile device, a request to transmit a payment from an account associated with the second mobile device to an account associated with the first mobile device; and
transmitting, by the computer to the second mobile device, a confirmation of the requested payment.

2. The computer-implemented method of claim 1, wherein the computer includes the first mobile device in the list in response to the computer receiving from the first mobile device an indication that the first device is ready to receive a payment.

3. The computer-implemented method of claim 1, further comprising:
receiving, by the computer from the first mobile device, a unique identifier for the first mobile device and an email address to associate with the first mobile device, wherein the computer initiates the payment using the unique identifier for the first mobile device and the email address associated with the first mobile device.

4. The computer-implemented method of claim 1, wherein multiple email addresses are associated with the account associated with the second mobile device.

5. The computer-implemented method of claim 1, wherein the computer receives a request from the first mobile device to enable the first mobile device to receive payments during a time period in which the first mobile device moves between geolocations that are a greater distance than the threshold distance and the determined geolocation of the first mobile device is a transient location.

6. The computer-implemented method of claim 1, further comprising:
determining a plurality geolocations of the first or second mobile device over time;
calculating an estimated rate of change between the determined geolocations of the first or second mobile device;
determining that an updated geolocation of the first or second mobile device is at a distance greater than a threshold distance from a recent geolocation of the first or second mobile device based upon the estimated rate of change; and
preventing a transaction for the first or second mobile device at the updated geolocation in response to determining that the updated geolocation of the first or second mobile device is at a distance greater than the threshold distance.

7. The computer-implemented method of claim 1, wherein the list of one or more mobile devices is ordered, the order based upon distance between each of the one or more mobile devices and the second mobile device, a trust rating associated with each of the one or more mobile devices, or a transaction history between the second mobile device and each of the one or more mobile devices.

8. The computer-implemented method of claim 1, wherein each entry in the list of one or more mobile devices includes an item, service, or donation request.

9. The computer-implemented method of claim 1, wherein the account associated with the first mobile device receives payments through a plurality of persons including a user of the first mobile device, the method further comprising:
generating a record to attribute to the first user the payment from the second mobile device to the account associated with the first mobile device.

10. The computer-implemented method of claim 1, further comprising:
receiving a request from the second mobile device to establish a recurring payment from the account associated with the second mobile device to the account associated with the first mobile device when the second mobile device is determined to be within a selected or default distance to the first mobile device; and
automatically initiating the recurring payment in response to determining that second mobile device is within the selected or default distance to the first mobile device.

11. The computer-implemented method of claim 1, further comprising:
receiving an instruction from the first mobile device to limit a listing of an item, service, or donation request to a geographical area;
determining that the geolocation of the first device is not within the geographical area; and
transmitting a list of payment options to the second mobile device in response to receiving the selection of the first mobile device from the list, wherein the list of payment options omits the item, service, or donation request in response to determining that the geolocation of the first device is not within the geographical area.

12. The computer-implemented method of claim 1, further comprising:
determining a geolocation associated with an IP address used by the first mobile device or a geolocation associated with a wireless network identifier received from the first mobile device, wherein the first mobile device is included in the list of one or more mobile devices in response to a received geolocation of the first mobile device being consistent with the geolocation associated with the IP address or the geolocation associated with the wireless network identifier.

13. A non-transitory computer-readable medium storing instructions, which when executed by a computer including a processing device, cause a computer to perform a method comprising:
determining, by the computer, that a geolocation of a first mobile device is within a threshold distance from a geolocation of a second mobile device;
transmitting, by the computer to the second mobile device, a list of one or more mobile devices within the threshold distance from the geolocation of the second mobile device, the list including the first mobile device;
receiving, by the computer from the second mobile device, a selection of the first mobile device from the list;
receiving, by the computer from the second mobile device, a request to transmit a payment from an account associated with the second mobile device to an account associated with the first mobile device; and
transmitting, by the computer to the second mobile device, a confirmation of the requested payment.

14. The non-transitory computer-readable medium of claim 13, wherein the computer receives a request from the first mobile device to enable the first mobile device to receive payments during a time period in which the first mobile device moves between geolocations that are a greater distance than the threshold distance and the determined geolocation of the first mobile device is a transient location.

15. The non-transitory computer-readable medium of claim 13, the method further comprising:
determining a plurality geolocations of the first or second mobile device over time;
calculating an estimated rate of change between the determined geolocations of the first or second mobile device;
determining that an updated geolocation of the first or second mobile device is at a distance greater than a threshold distance from a recent geolocation of the first or second mobile device based upon the estimated rate of change; and
preventing a transaction for the first or second mobile device at the updated geolocation in response to determining that the updated geolocation of the first or second mobile device is at a distance greater than the threshold distance.

16. The non-transitory computer-readable medium of claim 13, wherein the list of one or more mobile devices is ordered, the order based upon distance between each of the one or more mobile devices and the second mobile device, a trust rating associated with each of the one or more mobile devices, or a transaction history between the second mobile device and each of the one or more mobile devices.

17. The non-transitory computer-readable medium of claim 13, wherein the account associated with the first mobile device receives payments through a plurality of persons including a user of the first mobile device, the method further comprising:
generating a record to attribute to the first user the payment from the second mobile device to the account associated with the first mobile device.

18. The non-transitory computer-readable medium of claim 13, the method further comprising:
receiving a request from the second mobile device to establish a recurring payment from the account associated with the second mobile device to the account associated with the first mobile device when the second mobile device is determined to be within a selected or default distance to the first mobile device; and
automatically initiating the recurring payment in response to determining that second mobile device is within the selected or default distance to the first mobile device.

19. The non-transitory computer-readable medium of claim 13, the method further comprising:
receiving an instruction from the first mobile device to limit a listing of an item, service, or donation request to a geographical area;
determining that the geolocation of the first device is not within the geographical area; and
transmitting a list of payment options to the second mobile device in response to receiving the selection of the first mobile device from the list, wherein the list of payment options omits the item, service, or donation request in response to determining that the geolocation of the first device is not within the geographical area.

20. An apparatus comprising:
a computer including a processing device, wherein the processing device executes instructions that cause the computer to perform a method comprising:
determining, by the computer, that a geolocation of a first mobile device is within a threshold distance from a geolocation of a second mobile device;
transmitting, by the computer to the second mobile device, a list of one or more mobile devices within the threshold distance from the geolocation of the second mobile device, the list including the first mobile device;
receiving, by the computer from the second mobile device, a selection of the first mobile device from the list;
receiving, by the computer from the second mobile device, a request to transmit a payment from an account associated with the second mobile device to an account associated with the first mobile device; and
transmitting, by the computer to the second mobile device, a confirmation of the requested payment.
